(19) United States
(12) Patent Application Publication
(10) Pub. No.: US 2019/0138006 A1
(43) Pub. Date: May 9, 2019

(54) Method and Control Unit for Stabilizing a Supply Network

(71) Applicant: Bayerische Motoren Werke Aktiengesellschaft, Muenchen (DE)

(72) Inventor: Enrique MARCIAL-SIMON, Veitshoechheim (DE)

(21) Appl. No.: 16/234,736

(22) Filed: Dec. 28, 2018

Related U.S. Application Data
(63) Continuation of application No. PCT/EP2017/065335, filed on Jun. 22, 2017.

(30) Foreign Application Priority Data
Jul. 1, 2016 (DE) 10 2016 212 026.3

(51) Int. Cl. G05D 1/00; B60L 50/60; B60L 53/63

(52) U.S. Cl. CPC G05D 1/0088; B60L 53/63; B60L 50/60

(57) ABSTRACT

A method distributes vehicles to a plurality of regionally distributed charging stations, which charging stations draw electrical power from a power supply network and/or provide electrical power to the power supply network at different points. The method determines a regional load distribution within the power supply network. The method directs a vehicle to a first charging station from the plurality of regionally distributed charging stations in accordance with the regional load distribution.

### CROSS REFERENCE TO RELATED APPLICATIONS

This application is a continuation of PCT International Application No. PCT/EP2017/065335, filed Jun. 22, 2017, which claims priority under 35 U.S.C. § 119 from German Patent Application No. 10 2016 212 026.3, filed Jul. 1, 2016, the entire disclosures of which are herein expressly incorporated by reference.

### BACKGROUND AND SUMMARY OF THE INVENTION

The invention relates to a method and a corresponding control unit for stabilizing a power supply network which is used for charging the energy storage devices of electrically driven vehicles.

An electrically driven vehicle has an electrical energy storage device, which typically needs to be coupled regularly to a charging station in order to charge the energy storage device with electrical energy from a power supply system, in particular a public power supply network. In this case, the simultaneous charging of the energy storage devices of a plurality of vehicles can result in a significant load, in particular in a load imbalance, on a supply network.

The present document is based on the technical object of providing a method and a corresponding control unit by which loads on a supply network, for example as a result of the charging operations of vehicles, can be reduced.

In accordance with one aspect of the invention, a method is described for distributing vehicles between a plurality of regionally distributed charging stations, which, at different points, draw electrical power from a power supply network and/or provide electrical power to the power supply network. By use of the charging stations, therefore, at different locations or points, electrical power can be either drawn from the supply network for charging operations of vehicles or can be provided to the supply network by way of discharge operations of the vehicles. This can result in a regional distribution of the load or in a regional load distribution of the supply network. The method can be implemented by use of a server, for example.

The method comprises determining a regional load distribution within the power supply network. In this case, the regional load distribution can indicate the electrical power that is being drawn from the power supply network or provided to the power supply network at the different points at a specific time.

In addition, the method comprises directing a vehicle to a first charging station from the plurality of regionally distributed charging stations, depending on the regional load distribution. The vehicle can then be used, by means of a charging operation and/or by means of a discharge operation, to adapt or alter the regional load distribution. Thus, loads (in particular load imbalances) on a supply network can be reduced.

A regional setpoint distribution can indicate the electrical power that should be drawn from the power supply network and/or provided to the power supply network at the different points at the specific time. The vehicle can be directed to a first charging station from the plurality of regionally distributed charging stations depending on the regional setpoint distribution. In this case, the first charging station can be selected in such a way that the regional load distribution is brought close to the regional setpoint distribution by a charging operation and/or discharge operation of the vehicle at the first charging station. Thus, loads on the supply network can be reduced in a precise manner.

The method can comprise determining distance data which indicate a distance between the vehicle and the first charging station. Alternatively or additionally, the method can comprise determining state of charge data which indicate a state of charge of an electrical energy storage device of the vehicle. Then, the vehicle can be directed to the first charging station depending on the distance data and/or the state of charge data. In particular, the first charging station can be selected depending on the distance data and/or the state of charge data. Thus, the load on a supply network can be reduced in a reliable manner.

By way of example, the vehicle can only be directed to the first charging station when the state of charge of an electrical energy storage device of the vehicle reaches or exceeds a state of charge threshold value. The state of charge threshold value can in this case depend on the distance data. Alternatively or additionally, the vehicle can only be directed to the first charging station when an energy consumption for a travel distance to the first charging station is equal to or less than a consumption energy threshold value. Alternatively or additionally, the vehicle can only be directed to the first charging station when a quantity of electrical energy which can be drawn at the first charging station is equal to or greater than a charging energy threshold value. Thus, it is possible to ensure that the first charging station is only approached when this is possible or sensible. Consequently, the load on a supply network can be reduced in a reliable manner.

The method can comprise determining or predicting an arrival time of the vehicle at the first charging station. The first charging station can then be reserved for a charging operation or for a discharge operation starting from the arrival time. Thus, the load on a supply network can be reduced in a reliable manner.

The vehicle may be a self-driving vehicle, with the result that the vehicle can be driven to the first charging station autonomously, i.e. without the intervention or possibly without the presence of a driver. Thus, vehicles can be used (for example during the working time of the users) flexibly for reducing loads on a supply network. Alternatively, a driver of the vehicle can be prompted (for example by means of an indication within the vehicle) to drive the vehicle to the first charging station.

The vehicle can already be connected to a second charging station from the plurality of regionally distributed charging stations for a charging operation and/or discharge operation. The steering of the vehicle can comprise changing from the second charging station to the first charging station in order to continue the charging operation and/or the discharge operation. Thus, unbalanced loads on the supply network can be compensated for in a flexible manner.

In accordance with a further aspect, a control unit is described for a system comprising a plurality of regionally distributed charging stations, which, at different points, draw electrical power from a power supply network and/or provide electrical power to the power supply network. The control unit is designed to determine a regional load distribution within the power supply network. In addition, the control unit is designed to direct or drive a vehicle to a first charging station from the plurality of regionally distributed charging stations depending on the regional load distribution.

In accordance with a further aspect, a vehicle (in particular a road vehicle, for example a passenger vehicle, a heavy goods vehicle or a motorcycle) is described which is designed to communicate with a control unit described in this document in order to determine a suitable charging station for a charging operation and/or a discharge operation.

In accordance with a further aspect, a software (SW) program is described. The SW program can be designed for implementation on a processor (for example a server) and for thereby implementing the method described in this document.

In accordance with a further aspect, a storage medium is described. The storage medium can comprise a software SW program which is designed for implementation on a processor and for thereby implementing the method described in this document.

It should be noted that the methods, apparatuses and systems described in this document can be used both on their own and in combination with other methods, apparatuses and systems described in this document. Furthermore, any aspects of the methods, apparatuses and systems described in this document can be combined with one another in many ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary system for charging or discharging the energy storage devices of electrically driven vehicles.

FIG. 2 is a flowchart of an exemplary method for controlling a charging operation or a discharge operation of a vehicle.

### DETAILED DESCRIPTION OF THE DRAWINGS

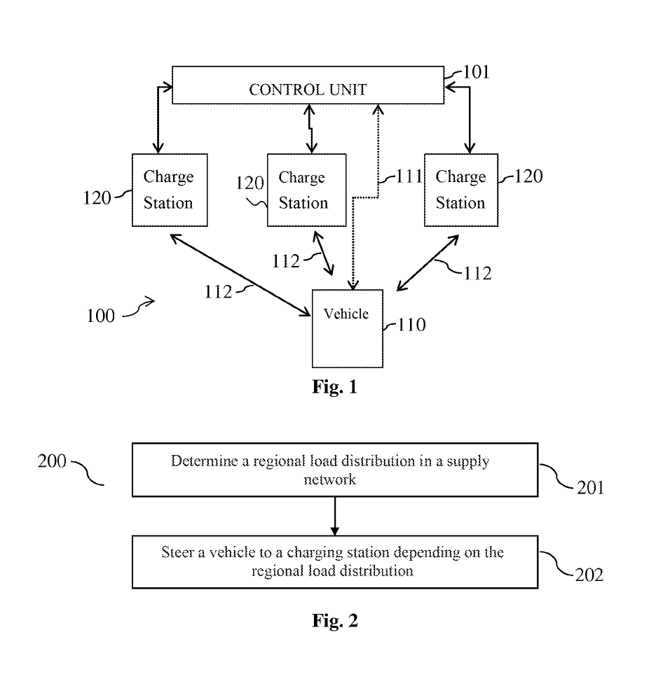

As set out at the outset, the present document is concerned with the reduction in the load on a power supply network owing to the charging operations of electrically driven vehicles. In this context, FIG. 1 shows a system 100 comprising a plurality of charging stations 120, which are distributed regionally within a supply network. In particular, the different charging stations 120 draw current for charging a vehicle 110 at different points within the supply network.

The users of vehicles 110 typically have a similar use behavior. In particular, vehicles 110 are typically used in the morning to drive from a residential area to work in a commercial or industrial area. The vehicles 110 can then be charged at charging stations 120 in the commercial or industrial area. In the evening, the vehicles 110 are then used to drive back to the residential area, in which the vehicles 110 can then be charged at charging stations 120 in the residential area. Owing to the statistically similar behavior of users of electrically driven vehicles 110, regionally different loads on a supply network may result. In particular, charging stations 120 in a first area can be used temporarily, while charging stations 120 in a second area remain unused. This can result in regional load imbalances on a supply network.

The system 100 can comprise a control unit 101, which is designed to determine a regional load distribution within a supply network. In particular, the control unit 101 can in this case determine the electrical power which is drawn from the supply network or output to the supply network by differently positioned charging stations 120. The control unit 101 can then direct a vehicle 110 to one of the plurality of charging stations 120 for a charging operation or discharge operation depending on the determined regional load distribution. Thus, the extent of regional differences in the load on the supply network can be reduced.

In particular, the supply network can have a regional setpoint distribution, and a regional actual distribution can be determined by the control unit 101. A vehicle 110 can then be directed to a charging station 120 in such a way that the regional actual distribution is brought close to the regional setpoint distribution. In other words, a charging station 120 can be chosen for a charging operation or discharge operation of a vehicle 110 so that the regional actual distribution is brought close to the regional setpoint distribution.

In order that vehicles 110 which do not allow any long interruptions to charging or which can contribute to compensation of load imbalances also participate in the energy regulation market, vehicles 110 can thus be driven, if required, to other charging stations 120 (located in the vicinity) or driven autonomously to other charging stations 120 (located in the vicinity). Corresponding stimulation for approaching a specific charging station 120 can originate from the vehicle 110, from a charging station 120 or typically from a central control unit 101 (for example a backend server).

In order to ensure that a charging station 120 to be approached remains free while a vehicle 110 is moving towards it, the vehicle 110 can transmit vehicle data 111 to the control unit 101 in order to indicate that a specific charging station 120 is being approached and that the specific charging station 120 should be reserved.

Distance data 112 between a vehicle 110 and a charging station 120 to be approached can be taken into consideration in the selection of a charging station 120. Furthermore, the state of charge of the energy storage device of a vehicle 110 can be taken into consideration. For example, a charging station 120 can only be approached or changed when a certain state of charge (SOC) threshold value has been reached or exceeded. Thus, a user can be protected from an excessively low state of charge. In addition, the required energy consumption for approaching or changing a charging station 120 can be taken into consideration. For this purpose, the required travel distance (for example outward journey and return journey) from the present position of the vehicle 110 to the position of the charging station 120 can be taken into consideration. Should the travel distance be too great and/or the subsequent charging time too short in order to make the vehicle 110 available again in good time with a sufficient SOC at the preferred location of the vehicle user, no change of charging station 120 can be performed or the approach to a proposed charging station 120 can be dispensed with. In such a case, the control unit 101 can dispense with directing the vehicle 110 to a specific charging station 120.

By suitably distributing vehicles 110 between differently positioned charging stations 120, the network capacity utilization and network stability of a supply network can be optimized regionally. Information in relation to the distribution of the vehicles 110 can be transmitted from a central control unit 101 (for example a network operator) to the fleet management system of a fleet of vehicles 110 and/or directly to vehicles 110 (for example to navigation devices of the vehicles 110). In order to instruct a vehicle 110 to drive up to a specific charging station 120, incentives (for example energy price discounts) can be used, if appropriate, in order to reward the vehicles 110 for avoiding load imbalances on the supply network.

FIG. 2 is a flowchart of an exemplary method 200 for distributing vehicles 110 between a plurality of regionally distributed charging stations 120, which, at different points, draw electrical power from a power supply network and/or provide electrical power to the power supply network. The method 200 comprises determining 201 a regional load distribution within the power supply network. In addition, the method comprises directing or driving 202 a vehicle 110 to a first charging station 120 from the plurality of regionally distributed charging stations 120, depending on the regional load distribution.

By virtue of the described method 200, regional load imbalances on a supply network can be avoided. Furthermore, the network stability can be improved and the capacity utilization of charging stations 120 can be optimized.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for distributing vehicles between a plurality of regionally distributed charging stations, which, at different points, draw electrical power from a power supply network and/or provide electrical power to the power supply network, the method comprising the acts of:
determining a regional load distribution within the power supply network; and
directing a vehicle to a first charging station from the plurality of regionally distributed charging stations, depending on the regional load distribution.

2. The method as claimed in claim 1, wherein
the regional load distribution indicates the electrical power that is being drawn and/or provided at the different points in the power supply network at a specific time;
a regional setpoint distribution indicates the electrical power that should be drawn and/or provided at the different points in the power supply network at the specific time; and
the vehicle is directed to the first charging station from the plurality of regionally distributed charging stations depending on the regional setpoint distribution.

3. The method as claimed in claim 2, wherein
the regional load distribution is brought close to the regional setpoint distribution by a charging operation and/or a discharge operation of the vehicle at the first charging station.

4. The method as claimed in claim 1, further comprising the acts of:
determining distance data which indicate a distance between the vehicle and the first charging station; and
directing the vehicle to the first charging station depending on the distance data.

5. The method as claimed in claim 4, further comprising the acts of:
determining state of charge data which indicate a state of charge of an electrical energy storage device of the vehicle; and
directing the vehicle to the first charging station depending on the state of charge data.

6. The method as claimed in claim 1, further comprising the acts of:
determining state of charge data which indicate a state of charge of an electrical energy storage device of the vehicle; and
directing the vehicle to the first charging station depending on the state of charge data.

7. The method as claimed in claim 5, wherein the vehicle is only directed to the first charging station when one or more of:
(i) the state of charge of an electrical energy storage device of the vehicle reaches or exceeds a state of charge threshold value;
(ii) an energy consumption for a travel distance to the first charging station is equal to or less than a consumption energy threshold value; and
(iii) a quantity of electrical energy which can be drawn at the first charging station is equal to or greater than a charging energy threshold value.

8. The method as claimed in claim 1, further comprising the acts of:
determining an arrival time of the vehicle at the first charging station; and
reserving the first charging station for a charging operation and/or a discharge operation starting from the arrival time.

9. The method as claimed in claim 1, wherein
the vehicle is a self-driving vehicle; and
the vehicle is driven to the first charging station autonomously, without intervention of a driver.

10. The method as claimed in claim 1, wherein
the vehicle is connected to a second charging station from the plurality of regionally distributed charging stations for a charging operation and/or discharge operation; and
the directing of the vehicle comprises changing from the second charging station to the first charging station in order to continue the charging operation and/or discharge operation.

11. A control unit for a system comprising a plurality of regionally distributed charging stations, which, at different points, draw electrical power from a power supply network and/or provide electrical power to the power supply network, wherein the control unit is configured to:
determine a regional load distribution within the power supply network; and
direct a vehicle to a first charging station from the plurality of regionally distributed charging stations depending on the regional load distribution.
